(19) United States
(12) Patent Application Publication
(10) Pub. No.: US 2013/0294564 A1
(43) Pub. Date: Nov. 7, 2013

(54) METHOD FOR DETECTING AND/OR MEASURING DEFECTS

(71) Applicant: WesDyne Sweden AB, (US)

(72) Inventor: David Stenman, Sala (SE)

(21) Appl. No.: 13/846,117

(22) Filed: Mar. 18, 2013

(30) Foreign Application Priority Data
Mar. 19, 2012 (SE) 1250257-1

(51) Int. Cl. G21C 17/00

(52) U.S. Cl. CPC G21C 17/00
USPC 376/245

(57) ABSTRACT

The present invention relates to a method of detecting and/or measuring defects in at least one part. The method includes providing a neutron source that produces a neutron flux, arranging the neutron source such that the neutron flux at least partly penetrates said part, providing a detection device for detecting neutrons, providing a hydrogen containing substance on a surface of said part such that the hydrogen containing substance penetrates into defects in said part, arranging the detection device to detect neutrons from the neutron flux that have been reflected by said substance, and detecting and/or measuring at least one possible defect in said part using the detection device to detect defects by detecting said reflected neutrons.

### THE FIELD OF THE INVENTION

The present invention refers to a method of detecting and/or measuring defects in at least one part. The part may for example be a part that is used or that has been used or that is designed for use in an industrial plant, building or vehicle, in particular in a nuclear power plant.

### BACKGROUND

The high requirements for the safety in for example a nuclear power plant, necessitate efficient and reliable detection and measurement of surface defects on different parts utilized in the nuclear power plant. Surface defects also occur in for example buildings, such as bridges, and transport vehicles, such as boats or airplanes.

Such defects in material may occur due to temperature exposure, corrosion, erosion, overload, buckling, aging, irradiation, post irradiation treatments and the like.

Many techniques have been developed to identify defects on surfaces, especially on surfaces of parts used or to be used in nuclear power plants. The USNRC (US Nuclear Regulatory Commission) and similar authorities in other countries require a continues assurance of leak-tight integrity of the nuclear power plant.

The methods and techniques used today for the identification and characterization of defects in surfaces of parts of the nuclear power plant include for example x-ray analysis, ultra sound detection, light scattering analysis, scanning electron microscopy, Eddy current inspection and moulding. Such techniques are also used for identification and characterization of defects on surfaces in other contexts.

The choice of technique depends for example on the composition of the material to be examined and the accessibility of the material. A disadvantage of some techniques is that the ongoing process in for example the nuclear reactor needs to be rerouted or stopped before the technique can be applied. Some techniques require dismantling of enclosed parts that need to be measured to allow access to such parts. Other techniques use an apparatus that cannot be moved within the plant and require the part to be transported to the apparatus. This makes it impossible to identify defects during ongoing operations. Most techniques use bulky equipment, which do not allow for measurements in confined spaces.

Only a few techniques can measure through materials. X-ray and ultrasound measurements are techniques frequently used to measure and detect defects through materials. However, these techniques are dependent on the composition of the material of the part. Especially for materials such as stainless steel and concrete, these techniques are not suitable.

There is a need for a method that is insensitive to the composition of the material from which the part to be measured is made. There is also a need for a method, which enables measuring and/or detecting of defects in a part of for example a nuclear power plant during ongoing operations of the plant. There is also a need for a method, which can detect and/or measure defects in a part that is enclosed by another part and a method that can suitably be used in a confined space within the plant.

### SUMMARY

An object of the present invention is to provide a method for measuring and/or detecting defects during quality and safety controls of parts, utilized where other techniques such as X-ray and ultra sound measurements cannot be used. Another object is the provision of a method, which is less sensitive to the composition of the material from which the part to be measured is made. A further object is the provision of a method that can be used during an ongoing operation in a industrial plant, such as a nuclear power plant. The method preferably enables measurement and/or detection of defects in parts that are positioned within another part or which are located in a confined space. Yet a further object is to provide a method that can be used to identify and characterize a change in a defect over time.

The objects are achieved by a method as defined in at least the appended claims.

The method according to the present invention can be used to measure and/or detect a defect in materials such as stainless steel or concrete, where other techniques cannot be used. Because neutrons pass through such materials, the method can be used to measure and/or detect defects in the part that is enclosed within another part such as a part enclosed by concrete. No disassembling of the part is needed before a measurement can be performed. Furthermore, the method can be used irrespective of the thickness of the material of the part to be measured. The method can advantageously be used during an ongoing operation in an industrial plant, such as a nuclear power plant.

In one embodiment, the detection device is a mobile detection device, which can be transported between different locations. The mobility of the detection device improves the flexibility for the use of the method in different sites of for example a nuclear power plant. This improves the efficiency of the quality and safety controls that need to be performed in the plant.

In another embodiment, the detection device comprises a scintillator configured to convert energy from reflected neutrons into light and an imaging device configured to produce and register at least one image of the possible defect based on the light produced by said conversion by the scintillator. The use of the imaging device, such as a camera, allows for accurate recording of the result from the measurement. A further advantage is that the result may become available quickly after or even during the measurement.

In a further embodiment, the imaging device provides a sequence of images from the part to identify and characterize a change of a possible defect in the part. Some defects on or in the surface of the part to be measured change over time. For example a crack in the surface may originate from a minor scratch on the surface of the part. It is therefore interesting to measure changes in defects over time. The method of the present invention can thus be used for both static and dynamic analysis of the defect in the part.

In one embodiment, the sequence of images is taken over a period of at least 24 hours, preferably at least 7 days, more preferably at least 30 days.

In one embodiment, a control unit is provided and configured to control at least one of the neutron source or detection device. The handling of the different apparatuses is preferably coordinated. The use of the control unit enables such coordination and will thus improve the efficiency of the measurement and/or detection of defects in one or more parts.

In another embodiment, the neutron source is a mobile neutron source, which can be transported between different locations. The mobility of the neutron source will improve the efficiency of the quality and safety controls.

In a further embodiment, the neutron source is a linear accelerator. Linear accelerators are commercially available in different sizes and can easily be implemented in the method according to the invention.

In an alternative embodiment, the neutron source is provided by a nuclear fuel of a nuclear power plant. If neutrons are available from the nuclear fuel, these neutrons can efficiently be used in the method. In this case no separate neutron source is needed. This makes it easier to implement the method according to the invention and costs may be reduced.

In one embodiment, the hydrogen containing substance is water. Neutrons are reflected by hydrogen atoms. It is therefore important that the substance contains hydrogen atoms. Water is rich in hydrogen atoms and water is used in many industrial plants, such as at a nuclear power plant, or otherwise easily available at the plant. The water may be in liquid or gas form.

In another embodiment, the part is made of stainless steel and/or concrete.

In yet another embodiment, the part is positioned within another part made of cast stainless steel. Because neutrons penetrate through materials such as stainless steel and concrete, the method can advantageously be used to measure and/or detect defects in the part made from such materials or in the part enclosed by such materials.

In one embodiment, the defect is an irregularity in the surface of the part.

In another embodiment, the irregularity is a crack in the surface of the part. The method of the present invention allows for detection of hydrogen atoms present at or in the surface of the part. Therefore, any kind of defects at or in the surface of the part can be measured using the method of the present invention.

In another embodiment, the method is used for detecting and/or measuring defects in a part that is used or that has been used or that is designed for use in a nuclear power plant.

In a further embodiment, the method is used in a nuclear power plant .

### BRIEF DESCRIPTION OF THE DRAWINGS

FIG. 1 shows a flow chart of a method according to the invention

FIG. 2 shows schematically how the method of the invention may be executed

FIG. 3 shows an example of a detection device and control unit

FIG. 4a,4b show examples of defects in a surface of a part

FIG. 5 shows a schematic image that includes a crack in a pipe filled with water

### DETAILED DESCRIPTION

### Devices and Materials for Use in the Method of the Invention

As an example, the following description will describe the invention for detecting and/or measuring defects in a part for a nuclear power plant. However, as indicated above, the invention can be applied to any other part.

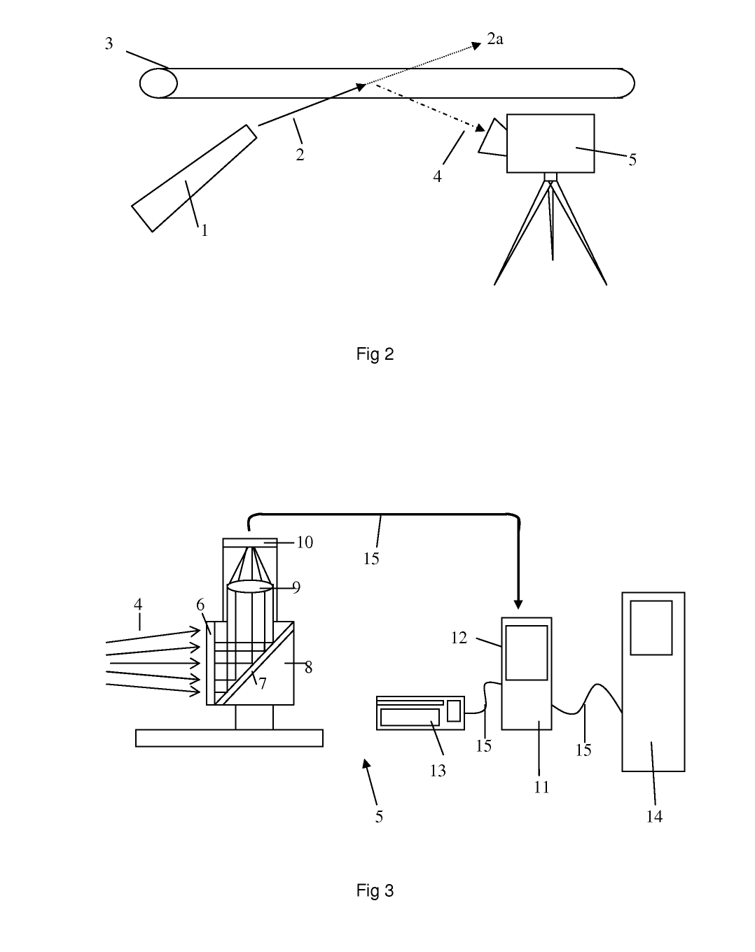

FIG. 2 shows a neutron source 1 that produces a neutron flux 2. The neutron flux 2 is directed towards a part 3, such as a pipe or basin. The neutrons 2a of a neutron flux 2 penetrate at least partly through the part 3. When the neutrons hit hydrogen atoms in their path, the neutrons will be reflected. The reflected neutrons 4 can be detected by a detection device 5.

The neutron source 1 may be a linear particle accelerator (linac). A linac is a type of particle accelerator that greatly increases the velocity of charged subatomic particles or ions by subjecting the charged particles to a series of oscillating electric potentials along a linear beamline. The linear accelerator uses microwave technology to accelerate electrons in a part of the accelerator called the “wave guide”. It then allows these electrons to collide with a heavy metal target. As a result of the collisions, high-energy neutrons are produced from the target. Suitable heavy metal targets may be tungsten, uranium, gold, lead, beryllium, mercury and the like, or combinations thereof. Depending on the energy of the neutrons, the neutrons may be slow, such as thermal neutrons, or fast. Linacs are known and commercially available from for example Toshiba or RadiaBeam Technologies.

The linac is available in different sizes. For the method of the present invention a linac having a length of one to two meters is preferably used. This provides for the possibility to transport the neutron source 1 between different locations or between different sites in the nuclear power plant and to use the method in confined spaces.

In some cases, it may be possible to use the neutron flux 2 produced by the nuclear fuel of the nuclear power plant as the neutron source 1. The neutron flux 2 produced by the nuclear fuel may be present in for example pipes and basins in the nuclear power plant. When measuring and/or detecting defects on such parts 3, there is no need for an additional neutron source 1.

Alternatively, the neutrons may be produced from a neutron source in the form of a fluid medium, such as water, and then applied to the part 3 in which to measure and/or detect any defects. For this purpose, a radioactive material in gas, liquid or solid form may be added to a fluid medium. This fluid medium with radioactive material may then be injected on the surface of the part 3. The medium may be injected as a beam of neutrons focused on a particular area on the surface of the part 3. Hereby, the beam may be focused from different angles relative to the surface of the part 3.

The neutron flux 2 produced by the nuclear fuel or by means of the fluid medium may also be diffuse as long as the neutrons produce sufficient light in the detection device 5 used for the measurement and/or detection. Examples of diffuse neutron sources may be neutrons originating from a leakage in the nuclear fuel or neutrons originating from nuclear waste.

Neutrons 4 that are reflected from hydrogen atoms that are present in the part 3 can be detected and visualized using a detection device 5. Such a device 5 allows detection and recording of a 2-dimensional image of the part 3. However, the neutron is not directly detected as light in a standard camera. A converter called a scintillator 6 can be used to convert neutrons to light and this light can then be recorded with an imaging device 7, 8, 9, 10 such as a camera or a digitizing device capable of recording light. The camera may be an analog or a digital camera.

FIG. 3 shows an example of a detection device 5. Reflected neutrons 4 are incident on a scintillator 6. The light from the scintillator 6 may then be reflected by a minor 7 in a light box 8 and forwarded to a camera lens 9. With help of a CCD chip 10, such as a Peltier cooled CCD ship, an image can be produced and registered, for example by using a computer 11. A screen 12 and input means 13, such a keyboard, may also be used. The different devices and apparatuses may be controlled by a control unit 14.

The control unit 14 may be used in the execution of the method. Such a unit 14 may be used to control the neutron source 1 and the detection device 5, which may comprise the scintillator 6, the imaging device 7, 8, 9, 10, the computer 11, the screen 12 and the input means 13. The different devices may be connected by cables 15 or the connections may be wireless.

Scintillators 6 are materials that transfer energy from a neutron to light. For scintillating purposes the neutron must first transfer some or all of its energy to a charged atomic nucleus. The positively charged nucleus then produces ionization. Different methods are available to perform this reaction. For example, fast neutrons (generally >0.5 MeV) primarily rely on the recoil proton in (n,p) reactions. Materials rich in hydrogen, e.g. plastic scintillators 6, are therefore best suited for their detection. Slow neutrons rely on nuclear reactions such as the (n,γ) or (n,α) reactions to produce ionization. For this purpose, the scintillator material 6 is loaded with elements having a high cross section for these nuclear reactions such as ⁶Li or ¹⁰B. Materials such as glass silicates are particularly good for the detection of slow (thermal) neutrons.

Different scintillators 6 may be used in the method of the invention. The choice may for example depend on the amount of radiation used at the site of the part 3 to be measured. Examples of suitable scintillators 6 are liquid organic scintillators, crystals, plastics and scintillation fibers.

The imaging device 7, 8, 9, 10 produces and registers at least one image of the possible defect based on the light produced by the conversion by the scintillator 6. To capture the image of the light created by the scintillator 6, different types of devices can be used. One example is a charge coupled device (CCD) type camera with a normal photographic quality focusing lens 9. Since most electronic devices are sensitive to radiation damage, it is necessary to protect the imaging device 7, 8, 9, 10 from neutron radiation 2, 4. The CCD device can be easily protected by mounting it outside the neutron radiation 2, 4. The focusing lens 9 forms an image on the CCD of the light image formed on the scintillator screen 7. Another device that may be employed is an amorphous silicon detector. This type of device is resistant to radiation damage.

Neutron detection devices 5 are commercially available, for example from Toshiba or Medway Technologies. Preferably, the detection device 5 is efficient, fast and sensitive. Noise that may be present in the images may be eliminated using de-noising operations used in the field of photography. The noise is preferably eliminated without affecting the measured signal.

The detection device 5, or at least the scintillator 6 and the imaging device 7, 8, 9, 10 used in the method according to the present invention, is preferably mobile so that it can be transported to different parts 3 present at the different sites of the nuclear power plant.

According to the method of the present invention, the neutron source 1 and the detection device 5 are arranged such that the reflected neutrons 4 from the neutron flux 2 can be detected (FIG. 2). The skilled artisan will understand how to arrange the neutron source 1 and detection device 5 in each individual situation, where the possible defect is to be measured.

Neutrons 4 are reflected by hydrogen atoms from hydrogen containing substances. It is therefore important for the method that such substances are provided at or in the part 3 to be measured. Examples of hydrogen containing substances are water, oils, waxes, smears and the like. Mixtures of two or more hydrogen containing substances may be used as well. The one or more hydrogen containing substances may be in any physical form such as gas, liquid, solid or even any mixture thereof. In a preferred embodiment, water is used in liquid form or as a gas.

The part 3 to be measured may, for example, be a wall of a pipe or a basin, or a valve, a baffle, a pump housing or a sealing ring. The part 3 may be located inside another part 3 such as a pipe inside a concrete housing. The method of the invention can be used irrespective of the thickness or granularity of the material of which the part 3 is composed.

The method of the invention

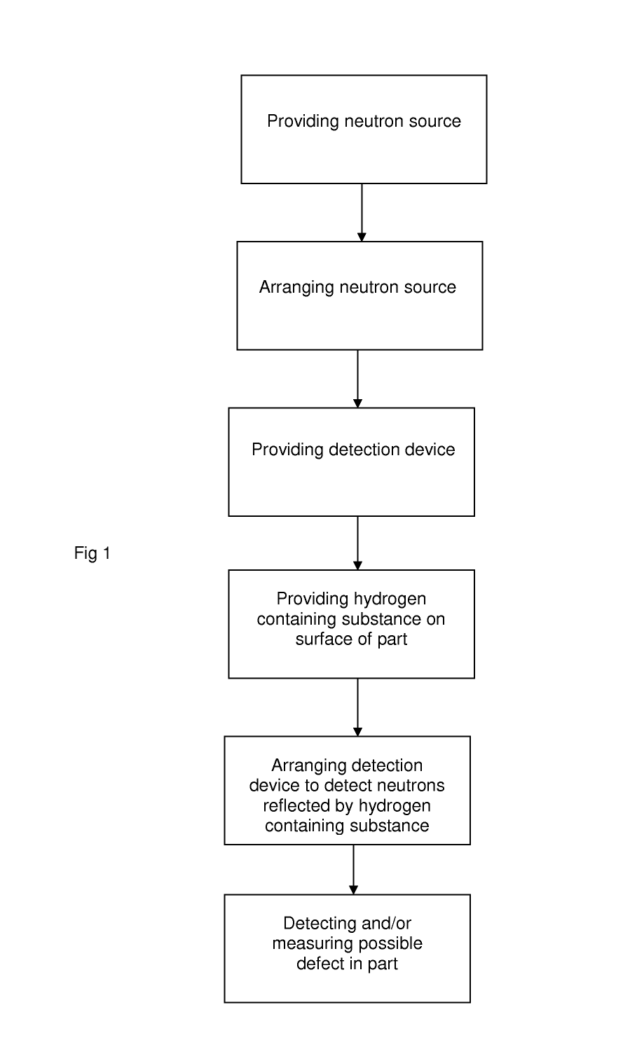

FIG. 1 shows a flow chart of a method of the invention.

The method comprises the steps of:

providing a neutron source 1 that produces a neutron flux 2,

arranging the neutron source 1, such that the neutron flux 2 at least partly penetrates the part 3,

providing a detection device 5 for detecting neutrons,

providing a hydrogen containing substance on a surface of said part 3, such that the hydrogen containing substance penetrates into defects in said part 3,

arranging the detection device 5 to detect neutrons from the neutron flux 2 that have been reflected by said substance, and

detecting and/or measuring at least one possible defect in said part 3 using the detection device 5 to detect defects by detecting said reflected neutrons 4.

The method can be used during routine inspections on different parts 3 positioned in the nuclear power plant. The method can also be used outside the nuclear power plant to measure and/or detect a possible defect in the part 3 that has been manufactured but not yet installed. After repair or installation of the part 3, but before taking the part 3 into use, the method may be used as well.

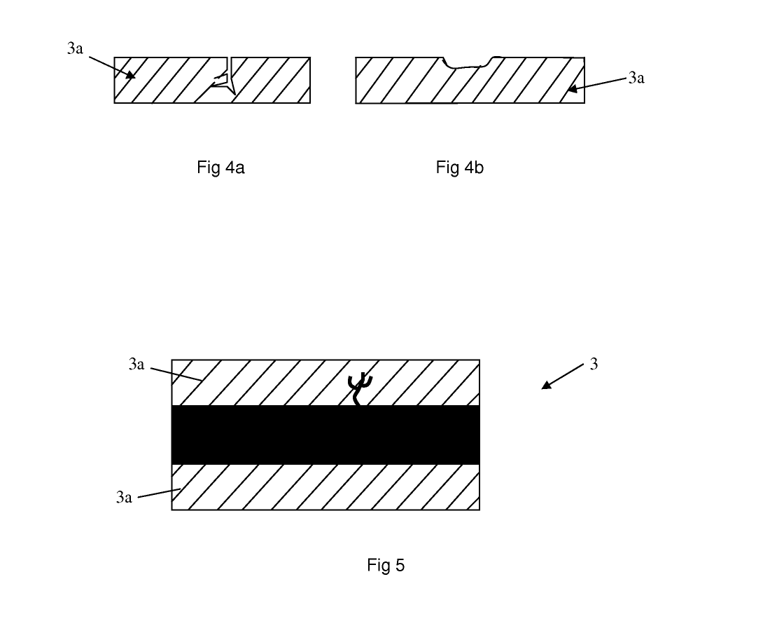

Different types of defects may be present in the part 3. The present invention is not limited to any type or size of defect and can be used for any irregularity in the surface of the part 3. FIGS. 4a and 4b show examples of irregularities in a wall 3a of a part 3 such as a pipe. FIG. 4a shows a crack and FIG. 4b shows a scratch in the surface of the wall 3a. More than one defect may be present in the part 3.

The hydrogen containing substance will enter into the defect in the surface of the part 3. For example by capillary action, the substance will be sucked into a crack in the surface of the part 3. Neutrons from a neutron flux 2 directed towards such a defect will be partly reflected by the hydrogen atoms present in the crack. These reflected neutrons 4 can be visualized using the detection device 5. Because the hydrogen atoms in the defect will reflect the neutrons, the method provides the possibility to detect very small defects. The precision of the method can be such that even the shape or form of the defect can be visualized.

The hydrogen containing substance on the produced image will be clearly contrasted to other materials in the part 3. An example is shown in FIG. 5, where a crack in the wall 3a of a pipe 3 can be seen. The pipe 3 is filled with (running) water.

Although the method can be used in parts 3 that are filled with a hydrogen containing substance, such as water, it may be advantageous, in some cases, to empty the part 3 before applying the method of the invention. After emptying, a hydrogen containing substance is provided on the surface of the part 3, whereafter the possible defect may be detected and/or measured. This emptying of the part 3 may improve the quality of the results obtained.

In order to detect and/or measure possible defects in a part 3, the hydrogen containing substance may also be provided on the surface of the part 3 by applying the substance for a short period of time and then removing the substance from the surface. The substance will remain inside the surface defects, such as cracks, and can be detected and/or measured. The substance may be liquid or gas, such as pressurized gas.

The method may be repeated by providing a hydrogen containing substance at the same surface repeatedly over time. By detecting and/or measuring the same defect once a week or once a month, changes in the defects can be identified and characterized.

Defects, such as a scratch, can also be detected because the distribution of hydrogen atoms from the hydrogen containing substance at and around the surface of the scratch will be different compared to the distribution of hydrogen atoms at the flat (non-defect) surface. A change in the distribution of the neutron scattering intensity around the scratch will be visible on the detector.

Another option is to measure a possible defect in a material by bending or stretching the material before applying the hydrogen containing substance. The hydrogen containing substance will enter into any defect in the part during stretching and bending of the material. The hydrogen atoms in such defects will reflect neutrons and can thus be detected.

The kind of information that can be obtained may be useful to predict changes in the defects over time. Other valuable information regards information about the size and nature of the defect. Both static and dynamic analysis of the defect may be performed using the method of the present invention.

The present invention is not limited to the embodiments disclosed but may be varied and modified within the scope of the following claims.

1. A method of detecting and/or measuring defects in at least one part, wherein the method comprises the following steps:
provide a neutron source that produces a neutron flux,
arrange the neutron source such that the neutron flux at least partly penetrates said part,
provide a detection device for detecting neutrons,
provide a hydrogen containing substance on at least one surface of said part such that the hydrogen containing substance penetrates into possible defects in said part,
arrange the detection device such that the detection device is adapted to detect neutrons from the neutron flux that have been reflected by said hydrogen containing substance, and
detect and/or measure at least one possible defect in said part by using the detection device to detect defects containing said substance by detecting said reflected neutrons.

2. The method according to claim 1, wherein the detection device is a mobile detection device, which can be transported between different locations.

3. The method according to claim 1, wherein the detection device comprises a scintillator configured to convert energy from reflected neutrons into light and an imaging device configured to produce and register at least one image of the possible defect based on the light produced by said conversion by the scintillator.

4. The method according to claim 3, wherein the imaging device provides a sequence of images from the part to identify and characterize a change of a possible defect in the part.

5. The method according to claim 4, wherein the sequence of images is taken over a period of at least 24 hours, preferably at least 7 days, more preferably at least 30 days.

6. The method according to claim 1, wherein a control unit is provided and configured to control at least one of the neutron source or detection device.

7. The method according to claim 1, wherein the neutron source is a mobile neutron source, which can be transported between different locations.

8. The method according to claim 1, wherein the neutron source is a linear accelerator.

9. The method according to claim 1, wherein the neutron source is provided by a nuclear fuel of a nuclear power plant.

10. The method according to claim 1, wherein the hydrogen containing substance is water.

11. The method according to claim 1, wherein the part is made of stainless steel and/or concrete.

12. The method according to claim 1, wherein the part is positioned within another part made of cast stainless steel.

13. The method according to claim 1, wherein the defect is an irregularity in the surface of the part.

14. The method according to claim 13, wherein the irregularity is a crack in the surface of the part.

15. The method according to claim 1, wherein the method is used for detecting and/or measuring defects in a part that is used or that has been used or that is designed for use in a nuclear power plant.

16. The method according to claim 1, wherein the method is used in a nuclear power plant.
